(19) United States
(12) Patent Application Publication
(10) Pub. No.: US 2014/0365277 A1
(43) Pub. Date: Dec. 11, 2014

(54) RETROACTIVE DOCUMENT RETENTION, REPORTING AND PRICING DETERMINATION

(71) Applicant: BANK OF AMERICA CORPORATION, Charlotte, NC (US)

(72) Inventors: Deborah N. Bennett, Conyers, GA (US); Deborah A. Copes, Wethersfield, CT (US); Timmy L. Gauvin, Peachtree City, GA (US)

(21) Appl. No.: 13/912,515

(22) Filed: Jun. 7, 2013

(51) Int. Cl. G06Q 30/02

(52) U.S. Cl. CPC G06Q 30/0206
USPC 705/7.35

(57) ABSTRACT

Embodiments of the invention relate to systems, methods, and computer program products for providing retroactive document retention service. In some embodiments, a system is provided that includes: a computing platform including a processor and a storage device, a database comprising rules relating to maintenance of information stored in an archive, a software module stored in the storage device comprising executable instructions that when executed by the processor cause the processor to: (a) identify one or more data items in the one or more databases having a retention date prior to a date of enrollment into the document retention service; (b) retroactively apply the document retention service to the one or more data items by modifying a retention time for each of the one or more data items, wherein the retention time is extend for a predetermined time in accordance with one or more terms of the document retention service.

### FIELD

In general, embodiments of the invention relate to systems for information management in an archive. More specifically, embodiments, of the invention relate to systems for retroactively applying a document retention program to customer records, for reporting, and price determination.

### BACKGROUND

Today, many financial institutions are required by federal and some state regulations to maintain image file records of all deposited checks, other negotiable instruments, and generally various financial documents related to customer accounts. In many instances, because of regulations, financial institutions are required to maintain this information for up to seven years and more, in certain situations. And so, many financial institutions have standing retention policies for storing customer data. But, in some cases, customers may require that their information be stored beyond the standard requirements. As such, there is a need to provide systems, apparatus, computer-implemented methods, and computer program products that enable entities and/or financial institutions to provide to properly the needs of their customers.

### BRIEF SUMMARY

The following presents a simplified summary of several embodiments of the invention in order to provide a basic understanding of such embodiments. This summary is not an extensive overview of all contemplated embodiments of the invention, and is intended to neither identify key or critical elements of all embodiments, nor delineate the scope of any or all embodiments. Its purpose is to present some concepts of one or more embodiments in a simplified form as a prelude to the more detailed description that is presented later.

Some embodiments of the present invention provide a system for providing retroactive document retention of documents and/or data associated with a participant in a document retention service that includes: a computing platform including at least one processor and a storage device, a database comprising one or more rules relating to maintenance of information stored in an archive, a software module stored in the storage device comprising executable instructions that when executed by the processor cause the processor to: (a) identify one or more data items in the one or more databases having a retention date prior to a date of enrollment into the document retention service; (b) retroactively apply the document retention service to the one or more data items by modifying a retention time for each of the one or more data items, wherein the retention time is extend for a predetermined time in accordance with one or more terms of the document retention service.

In some embodiments of the system, the software module further comprises executable instructions that when executed by the processor cause the processor to: aggregate information associated with the identified one or more data items in the one or more databases.

In some embodiments of the system, the software module further comprises executable instructions that when executed by the processor cause the processor to: generate a report based at least partially on the aggregated information associated with the identified one or more data items in the one or more databases.

In some embodiments of the system, the software module further comprises executable instructions that when executed by the processor cause the processor to: determine one or more features of the data items, wherein the one or more features include a file size and a retention date; and determine a price or cost for retroactively applying the document retention service to the one or more data items based at least partially on the report and/or the one or more features of each of the data items.

In some embodiments of the system, wherein the retention date is a date on which each of the one or more data items were stored within the one or more databases, and wherein the retention time is an amount of time each of the one or more data items will be stored beginning from the retention date for each of the one or more data items.

In some embodiments of the system, the software module further comprises executable instructions that when executed by the processor cause the processor to: use a pricing model to determine a price for the retroactive application of the document retention service to the one or more data items, wherein the pricing model comprises a plurality of variables for determining a price, where each of the plurality of variables relates to one or more of a plurality of features of each of the one or more data items.

In some embodiments of the system the document retention service comprises one or more terms for extending retention times of data items stored on or beyond the date of enrollment by the participant, and wherein the document retention service further comprises a retroactive document retention feature for applying the one or more terms to documents associated with the participant having the retention date prior to the date of enrollment of the document retention service.

In one aspect of the invention, a computer-implemented method is provided for providing retroactive document retention of documents and/or data associated with a participant in a document retention service. The computer-implemented method includes using a computer processor to execute computer program code instructions stored in one or more non-transitory computer-readable mediums, wherein said computer program code instructions are structured to cause said computer processor to: (a) identify one or more data items in the one or more databases having a retention date prior to a date of enrollment into the document retention service; (b) retroactively apply the document retention service to the one or more data items by modifying a retention time for each of the one or more data items, wherein the retention time is extend for a predetermined time in accordance with one or more terms of the document retention service.

In some embodiments of the computer-implemented method further comprising computer-code instructions that are structured to cause a computer processor to aggregate information associated with the identified one or more data items in the one or more databases.

In some embodiments of the computer-implemented method further comprising computer-code instructions that are structured to cause a computer processor to generate a report based at least partially on the aggregated information associated with the identified one or more data items in the one or more databases.

In some embodiments of the computer-implemented method further comprising computer-code instructions that are structured to cause a computer processor to determine one or more features of the data items, wherein the one or more features include a file size and a retention date; and determine a price or cost for retroactively applying the document retention service to the one or more data items based at least partially on the report and/or the one or more features of each of the data items.

In some embodiments of the computer-implemented method, wherein the retention date is a date on which each of the one or more data items were stored within the one or more databases, and wherein the retention time is an amount of time each of the one or more data items will be stored beginning from the retention date for each of the one or more data items.

In some embodiments the computer-implemented method further comprising computer-code instructions that are structured to cause a computer processor to use a pricing model to determine a price for the retroactive application of the document retention service to the one or more data items, wherein the pricing model comprises a plurality of variables for determining a price, where each of the plurality of variables relates to one or more of a plurality of features of each of the one or more data items.

In some embodiments the computer-implemented method the document retention service comprises one or more terms for extending retention times of data items stored on or beyond the date of enrollment by the participant, and wherein the document retention service further comprises a retroactive document retention feature for applying the one or more terms to documents associated with the participant having the retention date prior to the date of enrollment of the document retention service.

In another aspect, a computer program product for providing retroactive document retention of documents and/or data associated with a participant in a document retention service archive that includes a non-transitory computer-readable medium, wherein the non-transitory computer-readable medium comprises one or more computer-executable program code portions that, when executed by a computer, cause the computer to: (a) identify one or more data items in the one or more databases having a retention date prior to a date of enrollment into the document retention service; (b) retroactively apply the document retention service to the one or more data items by modifying a retention time for each of the one or more data items, wherein the retention time is extend for a predetermined time in accordance with one or more terms of the document retention service.

In some embodiments of the computer program product further comprising computer-readable code that when executed by a computer processor causes the computer to aggregate information associated with the identified one or more data items in the one or more databases.

In some embodiments of the computer program product further comprising computer-readable code that when executed by a computer processor causes the computer to generate a report based at least partially on the aggregated information associated with the identified one or more data items in the one or more databases.

In some embodiments of the computer program product further comprising computer-readable code that when executed by a computer processor causes the computer to determine one or more features of the data items, wherein the one or more features include a file size and a retention date; and determine a price or cost for retroactively applying the document retention service to the one or more data items based at least partially on the report and/or the one or more features of each of the data items.

In some embodiments of the computer program product, wherein the retention date is a date on which each of the one or more data items were stored within the one or more databases, and wherein the retention time is an amount of time each of the one or more data items will be stored beginning from the retention date for each of the one or more data items.

In some embodiments the computer program product further comprising computer-readable code that when executed by a computer processor causes the computer to use a pricing model to determine a price for the retroactive application of the document retention service to the one or more data items, wherein the pricing model comprises a plurality of variables for determining a price, where each of the plurality of variables relates to one or more of a plurality of features of each of the one or more data items.

In some embodiments the computer program product the document retention service comprises one or more terms for extending retention times of data items stored on or beyond the date of enrollment by the participant, and wherein the document retention service further comprises a retroactive document retention feature for applying the one or more terms to documents associated with the participant having the retention date prior to the date of enrollment of the document retention service.

Other aspects and features, as recited by the claims, will become apparent to those skilled in the art upon review of the following non-limited detailed description of the invention in conjunction with the accompanying figures.

### BRIEF DESCRIPTION OF THE DRAWINGS

Having thus described embodiments of the invention in general terms, reference will now be made to the accompanying drawings, wherein:

FIG. 1 illustrates a general process flow 100 for enrollment in document retention, in accordance with embodiments of the present invention;

FIG. 2 is a detailed process flow 200 for applying a retroactive document service to documents of a participant, according to embodiments of the present invention;

FIG. 3 is a block diagram of the system environment 300 for implementing a document retention service, in accordance with some embodiments of the present invention.

### DETAILED DESCRIPTION OF EMBODIMENTS OF THE INVENTION

Embodiments of the present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Present embodiments of the invention provide systems, methods, and computer program products that provide for the retroactive application of a retroactive document retention program to data, reporting, and pricing for the document retention program. Currently, a customer of an entity, such as a financial institution, may be able to enroll in a document retention program or service with the entity that extends the retention time for any of the customer's documents beyond the regulatory/legal requirements or document retention policies of the entity. However, the document retention plan only applies to documents or electronic data of the customer being stored beginning at the enrollment date of the document retention program. But, when a customer enrolls in the retroactive document retention program or has a retroactive document retention feature added to an existing document retention program, the entity is able to apply certain and/or all of the terms of extended storage of document retention program to electronic data and/or documents that were stored by the entity prior to the enrollment date into any of the document retention programs.

Thus, the application of the retroactive document retention program may be based at least partially on an enrollment date into one or more document retention programs or services offered by an entity. For example, if the date that a customer enrolls into a document retention program is Apr. 15, 2012 then if he customer also enrolls into the retroactive document retention program then the retroactive document retention program applies to any or all documents stored by the entity prior to Apr. 15, 2012.

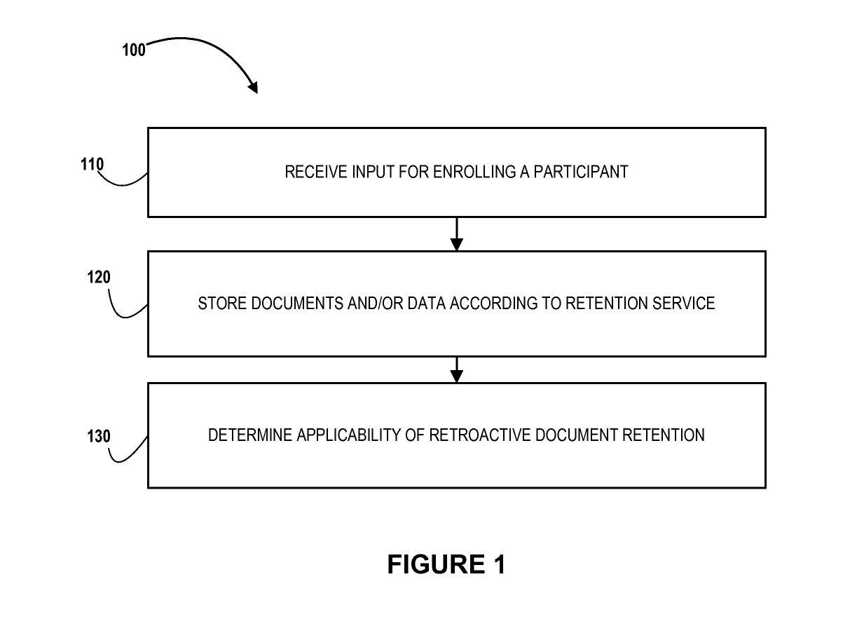

Referring now to FIG. 1, FIG. 1 illustrates a general process flow 100 for enrolling into a document retention service, in accordance with some embodiments of the present invention. As represented by block 110, a system executing process flow 100 receives input from a user for enrolling in a document retention program. The document retention program, in some embodiments, relates to a program that allows a client/customer and/or a division of an entity to subscribe to or participate in a program designed to retain documents and data associated with the client/customer or division of the entity for an extended period of time beyond the normal or legal requirements for storing said documents or data. In many embodiments, the documents and data associated with the client/customer is related to or may comprise of data that the entity would normally receive or produce for the customer/client in the regular course of business. For example, in some embodiments, the entity implementing the document retention program is a bank and the client a customer of the bank. In such embodiments, documents and data are produced resulting from various transactions between the bank and the customer that may include, but is not limited to, the customer depositing checks with the bank, the customer opening a mortgage account with the bank, the customer opening a non-mortgage loan with the bank, the customer receiving one or more account statements from the bank, and/or any other transaction that may involve the customer and the bank. Continuing with the example, in some instances, the bank has a legal requirement to store some of the data or documents related to these transactions and/or in other instances, the customer may want to keep records of the data and documents for various reasons. In many instances, the databases and/or archives used to store the documents of the clients/customers enrolled in the document retention program are managed, owned, and/or maintained by the entity of which the enrollee is a client or customer of. In other embodiments, the databases and/or archives are managed, owned, or maintained by a third party associated with the entity or under the control of the entity. In some embodiments, the entity is a business merchant, such as a financial institution or bank. In some embodiments, the document retention program only applies to information that the entity receives and stores beginning from the date of enrollment or some time thereafter. In other embodiments, the document retention program may retroactively apply the terms of the document retention program to previously stored data associated with the client/customer and/or division of the entity that exist in the database of the entity maintaining or implementing the document retention program. In some embodiments, prior to or contemporaneously with receiving the input from the user, the system presents the terms and conditions for participating in the document retention program. The terms and conditions for the program may be presented in any manner including by displaying via a user interface of a computing device of the consumer. By inputting information or by generally enrolling into the document retention program, the user accepts the terms and conditions of the program.

As represented by block 120, the system stores data and documents associated with the participant of the document retention program and apply an extended date of storage for the information. The extended date of storage of the information generally allows for information associated with the participant to be stored for a time exceeding the time for storing documents or information of a client/customer that is otherwise required by law, regulations, or internal policies of the entity offering the document retention program. For instance, it may be required by regulation that a financial institution store images of deposited checks or negotiable instruments for, at least, seven years prior to purging the files from the records of the financial institution. By implementing the document retention program, the system may extend the prospective purge date to a later date agreed upon by the participant and the financial institution (e.g., 10 years, 15 years, 20 years, and the like).

According to block 130, the system determines whether or not the user has existing information stored in the databases and archives of an entity associated with or implementing the document retention program. When the system determines that the user has existing information stored in the databases and/or archives of the entity, it automatically and retroactively applies the terms of the document retention program to the files that existed prior to the participant enrolling in the document retention program. In this way, the files that existed in the archives of the participant may obtain the same or similar benefit of the document retention program as the new files of information that will be stored on behalf of the participant.

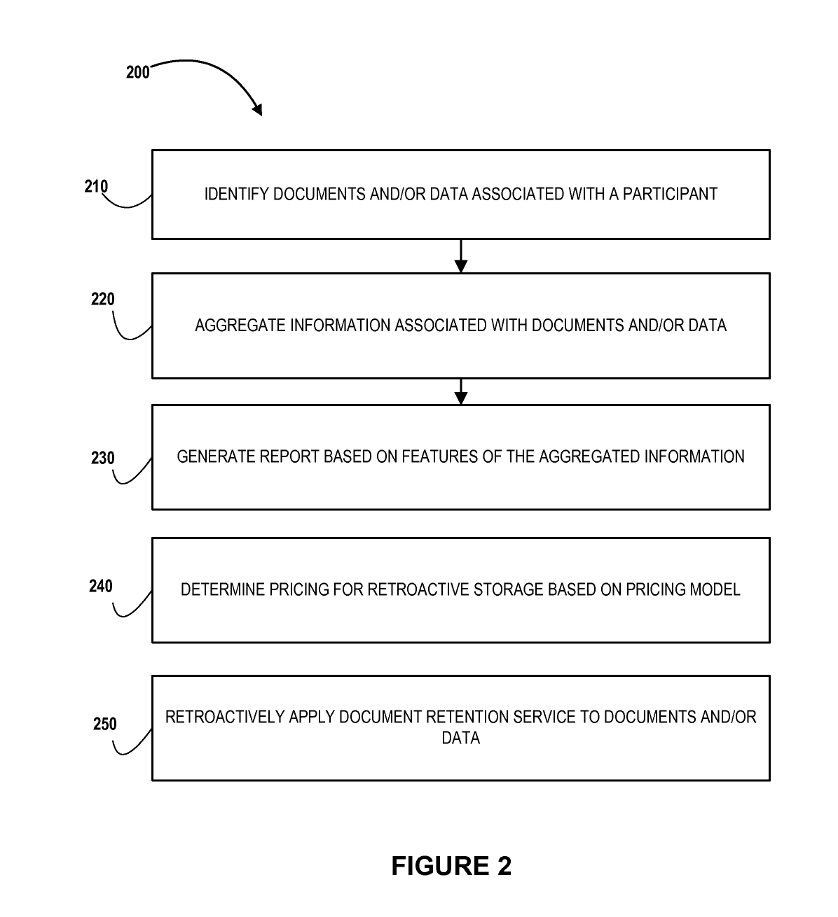

Referring now to FIG. 2, Figure illustrates a more detailed process flow 200, in accordance with some embodiments of the present invention. As represented by block 210, the system executing process flow 200 identifies any or all documents and/or data associated with a participant in a document retention program that are stored in databases and/or archives of an entity. In many embodiments, the system identifies only those documents and/or data associated with the participant that were stored prior to the enrollment and/or inception date of the document retention program. As an example, a customer may have been conducting various transactions with a bank beginning in the year 2000 and enrolled in a document retention program in 2010. In such an example, the system may search the databases and/or archives of the bank in order to identify any or all documents and/or data from transactions involving the customer and/or the bank. In some embodiments, the documents and/or data associated with a customer may be centrally located or stored in the databases and/or archives of the entity and as such, the information regarding those documents and/or data may simply be retrieved or provided to the system as input by an agent of the entity or user.

As referenced earlier herein, a document retention program is a program offered to customers of an entity that allows the customer to pay the entity an amount for storing data associated with the customer for a time period exceeding the amount of time the entity is legally required to store that data and/or documents. As such, a more accurate labeling of the program is a customer document retention program. Now, regarding the invention, one of the primary foci of the customer document retention program is the ability of a customer to enroll into the program and for some additional consideration or amount request that the customer document retention program be applied to documents associated with the customer stored prior to the customer's enrollment into the customer document retention program. In some instances, the process of retroactively applying the terms of the customer document retention program to documents prior to the enrollment date may be referred to herein as “retroactive document retention.”

At block 220, the system executing process flow 200 aggregates information associated with the documents and/or data of the customer. In some embodiments, the system aggregates information associated with the documents based on the identification of the data and/or documents of the customer that are prior to the enrollment date of the document retention service. The information aggregated from the identified documents and/or data may include, but is not limited to, document type or data type, initial storage date, storage location, a file size of the document and/or data, a current retention schedule for each of the documents and/or data items, and/or the like. As an example, the system may identify to previously stored documents associated with the customer and aggregate specific information of a first of the two documents that indicate that the document's file size is three megabytes (3 Mb), storage date is three years earlier than the enrollment date of the document retention service, scheduled removal or deletion date from its storage location is another 2 years from the current date, content includes a mortgage transaction involving the bank and the customer, and other features describing the stored document.

At block 230, the system generates a report based at least partially on one or more features of the aggregated information associated with the documents and/or data. The report that is generated by the system may be used for in many different manners by the system and/or administrators or agents. In the cases that the reports are used by the service administrators or agents, the report is useful for detailing the important features of the data that may drive the cost for storing the documents and/or data associated with the aggregated information. In many instances, the sizes of files and/or documents drive the cost of storage for an entity. And so, it may be important than an administrator or agent is aware of the amount of data that may be retroactively stored for an extended period of time. The reports may also provide critical insight into retention schedules for each document or element of data associated with the participant. The retention schedules may be the original schedules for each document or data item that dictate when the document or data item should be deleted, purged, and/or removed from its storage location. Because the service administrator and/or agent is aware of the retention schedule for each document and/or item, it provides the administrator or agent an opportunity to discuss impending deletions of customer data and the like with the participant. In some embodiments, the report may be presented to the participant so that the participant can selectively indicate which items of data it would like to fall under the service and the items of data that can remain under the standard retention policies of the entity. In this way, the system may receive the input and apply the retroactive document retention policy to only those documents and/or data items the participant selects for extended storage.

As represented by block 240, the system determines pricing for retroactively applying the document retention program based at least partially on the generated report and/or the aggregated information about the documents and/or data associated with the participant. In some embodiments, the system uses a pricing model for determining a price for the extended storage of the documents and/or data. In such an instances, the report and/or aggregated information relating to the documents and/or data may be used as input for the pricing model in order to thereby generate a price and/or a cost for extending the storage and/or retention schedules of the documents and/or data based on the retroactive document retention service.

Still regarding block 240, in some embodiments, the pricing model may include a plurality of variables related to the one or more features of the documents and/or data. In such embodiments, the pricing model may include a variable for a file size for each of the documents and/or data, a variable for the possible extension of time value, a variable for the type of document, a variable for whether the document will have to be moved and/or stored in a different manner (e.g., some database or archive locations may be more expensive to access), the amount of system and/or agent time for modifying retention dates, and the like. Thus, the model may have many variables with differing weights for each variable and price or cost factors associated with each variable. As an example, the price model may dictate that the price for storing each megabyte of a file per year is $5.00 per megabyte per year of extended retention and the price for storing a low important document is $1.00 per year of extended retention. So that, if a participant wishes to store a low importance file for two years having a file size of 5 megabytes, the pricing model would indicate a price to charge the participant of $52.00 ($5.00×5 Mb×2 yrs.+$1.00×2 yrs.=$52.00). The system may then output the price to the participant and/or amend the report to add the price for the retroactive document retention of the documents. It will be understood that this is just an example, the model may have more than two variables or factors for determining a price for extending the retention time of documents and/or data with retention dates prior to the enrollment date of the document retention service. Also, it will be understood that the participant and entity may agree on a fixed price for the document retention service for documents and/or data with retention dates on or beyond the enrollment date into the document retention service and a separate price for the documents and/or data with retention dates prior to the enrollment date.

At block 250, the system retroactively applies the document retention program to the documents and/or data items associated with the participant. In some embodiments, the system retroactively applies the document retention service to the documents and/or data items selected by the participant. According to some embodiments, the system retroactively applies the document retention service to the documents and/or data items of the identified group of documents and/or data associated with the participant that were stored prior to the participant's enrollment date into the document retention service. As such, if any documents and/or data items associated with the participant are identified as having a retention date earlier than the enrollment date into the document retention service, the retroactive document retention service determines new dates for each of the documents and/or data items according to the terms of the document retention service in which the participant has enrolled. The document retention service may have varying or consistent terms for the extended retention or storage of a participant's documents or data items. In some embodiments, the terms of a document retention service may also include terms and/or instructions that dictate additional treatments other than the extended storage including, but not limited to, the manner in which the items should be stored, items that should be stored together for ease of access, cross-linking related stored data items, and the like. As an example of applying the document retention service, a participant/customer of a bank may have enrolled in a retroactive document retention service with the bank that extends the retention time of a plurality of bank-related documents associated with the participant. The date of enrollment for the participant for this example is Jan. 1, 2007. The plurality of documents may include a first bank document having an original retention date of Jan. 1, 2005, a second bank document having a retention date of Jan. 1, 2004, and a third bank document having a retention date of Jan. 1, 2003, where each of the plurality of documents have a standard retention time of seven years prior to being deleted or moved from storage. The terms of the retroactive document retention service may dictate that any documents of the participant beginning on the enrollment date for a minimum of nine years (9 yrs.), which extends the retention date of the participant's documents by a minimum of two years (2 yrs.) beyond a standard seven year (7 yr.) retention policy for the bank. In such an example, the bank applies the document retention service retroactively so that even the participant's documents with retention dates prior to the enrollment date into the document retention service may have the benefit of the terms of the service. In this case and according to the terms of the document retention service, the participant's documents are retained by the bank for, at least, an additional two years in excess the bank's standard retention policy. As such, in applying the retroactive document retention feature of the service to the documents that were retained prior to the participant's enrollment date, the system will retroactively modify retention time of each of the plurality of documents to add an additional two years. Thus, resulting each of the plurality of documents having deletion and/or move from storage dates of 1^{st} document: Jan. 1, 2014, 2^{nd} document: Jan. 1, 2013, and 3^{rd} document: Jan. 1, 2012. This is just an example and thus, it will be understood that the terms of the document retention service may dictate different retention times for different types of documents and/or data based on their importance or relevance to the participant. Meaning, the first document may be saved for an additional 2 years, whereas the second document may be saved for an additional 10 years.

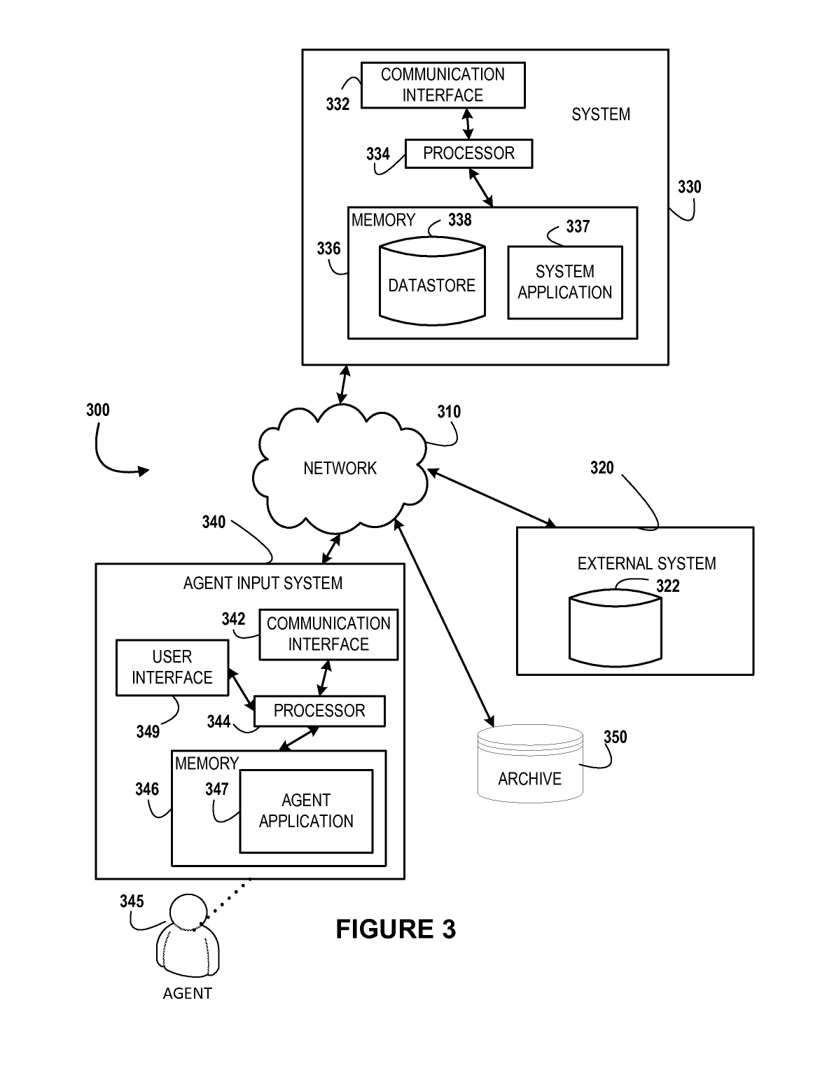

Referring now to FIG. 3, FIG. 3 presents an exemplary block diagram of the system environment 300 for implementing the process flows 100 and 200, described in FIGS. 1, and 2, in accordance with embodiments of the present invention. As illustrated, the system environment 300 includes a network 310, an external system 320, a system 330, an agent input system 340, and an archive 350. Also shown in FIG. 3 is an agent 345 of the agent input system 340. The agent 345 may be a person who uses the agent input system 340 to execute an agent application 347 or uses the agent input system 340 to initiate execution of a system application 337. The agent application 347 and/or the system application 337 may incorporate one or more parts of the process flows 100 and 200. The agent may be an employee of the entity that manages the system 330 and/or the external system 320. In other embodiments, the agent may not be an employee of an entity, but may still provide a service under the direction and/or supervision of the entity.

As shown in FIG. 3, the external system 320, the system 330, and the agent input system 340 are each operatively and selectively connected to the network 310, which may include one or more separate networks. In addition, the network 310 may include a local area network (LAN), a wide area network (WAN), and/or a global area network (GAN), such as the Internet. It will also be understood that the network 310 may be secure and/or unsecure and may also include wireless and/or wireline and/or optical interconnection technology.

The external system 320 may be any computing or non-computing system that transmits information to the system 330. Additionally or alternatively, information from the system 330 may be transmitted to the external system 320. As presented in FIG. 3, the external system 320 comprises at least one datastore 322. The datastore 322 may comprise information relating to at least one of a user, the user's financial institution account, user's information including documents and data stored in the archives or databases of the financial institution, and the like. As used herein, the terms “data” and “information” may be used interchangeably.

The agent input system 340 may include any computerized apparatus that can be configured to perform any one or more of the functions of the agent input system 340 described and/or contemplated herein. For example, the agent 345 may use the agent input system 340 to transmit and/or receive information or commands to and from the system 330. In some embodiments, for example, the agent input system 340 may include a personal computer system, a mobile computing device, a personal digital assistant, a network device, and/or the like. As illustrated in FIG. 3, in accordance with some embodiments of the present invention, the agent input system 340 includes a communication interface 342, a processor 344, a memory 346 having an agent application 347 stored therein, and an agent interface 349. In such embodiments, the communication interface 342 is operatively and selectively connected to the processor 344, which is operatively and selectively connected to the agent interface 349 and the memory 346. In some embodiments, the agent 345 may use the agent application 347 to execute processes described with respect to the process flows described herein, or may initiate the system 330 to execute the process flows described herein.

The archive 350 may include any computerized apparatus that can be configured to perform any one or more of the functions of the archive 350 described and/or contemplated herein. In addition, the archive 350 may include any physical structures and software elements to achieve the functions of the archive 350 described and/or contemplated herein.

Each communication interface described herein, including the communication interface 342, generally includes hardware, and, in some instances, software, that enables the agent input system 340, to transport, send, receive, and/or otherwise communicate information to and/or from the communication interface of one or more other systems on the network 310. For example, the communication interface 342 of the agent input system 340 may include a modem, server, electrical connection, and/or other electronic device that operatively connects the agent input system 340 to another system such as the system 330.

Each processor described herein, including the processor 344, generally includes circuitry for implementing the audio, visual, and/or logic functions of the agent input system 340. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the agent application 347 of the memory 346 of the agent input system 340.

Each memory device described herein, including the memory 346 for storing the agent application 347 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 3, the memory 346 includes the agent application 347. In some embodiments, the agent application 347 includes an interface for communicating with, navigating, controlling, configuring, and/or using at least one of the system 330 or the agent input system 340. In some embodiments, the agent application 347 includes computer-executable program code portions for instructing the processor 344 to perform one or more of the functions of the agent application 347 described and/or contemplated herein. In some embodiments, the agent application 347 may include and/or use one or more network and/or system communication protocols.

Also shown in FIG. 3 is the user interface 349. In some embodiments, the user interface 349 includes one or more output devices, such as a display and/or speaker, for presenting information to the agent 345. In some embodiments, the user interface 349 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the agent 345. In some embodiments, the user interface 349 includes the input and display devices of a personal computer, such as a keyboard and monitor, which are operable to receive and display information.

FIG. 3 also illustrates a system 330, in accordance with an embodiment of the present invention. The system 330 may include any computerized apparatus that can be configured to perform any one or more of the functions of the system 330 described and/or contemplated herein. In accordance with some embodiments, for example, the system 330 may include a computer network, an engine, a platform, a server, a database system, a front end system, a back end system, a personal computer system, and/or the like. In some embodiments, such as the one illustrated in FIG. 3, the system 330 includes a communication interface 332, a processor 334, and a memory 336, which includes a system application 337 and a datastore 338 stored therein. As shown, the communication interface 332 is operatively and selectively connected to the processor 334, which is operatively and selectively connected to the memory 336.

It will be understood that the system application 337 may be configured to implement any one or more portions of the various user interfaces and/or process flows described herein. It will also be understood that, in some embodiments, the memory includes other applications. It will also be understood that, in some embodiments, the system application 337 is configured to communicate with the datastore 338, the agent input system 340 and/or the external system 320.

It will be further understood that, in some embodiments, the system application 337 includes computer-executable program code portions for instructing the processor 334 to perform any one or more of the functions of the system application 337 described and/or contemplated herein. In some embodiments, the system application 337 may include and/or use one or more network and/or system communication protocols.

In addition to the system application 337, the memory 336 also includes the datastore 338. As used herein, the datastore 338 may be one or more distinct and/or remote datastores. In some embodiments, the datastore 338 is not located within the system and is instead located remotely from the system. In some embodiments, the datastore 338 stores information or data described herein. For example, the datastore 338 may store information relating to at least one of the user, schedules for managing data in the archive, rules related to the maintenance and management of the information in the archive, and the like.

It will be understood that the datastore 338 may include any one or more storage devices, including, but not limited to, archives, datastores, databases, and/or any of the other storage devices typically associated with a computer system. It will also be understood that the datastore 338 may store information in any known way, such as, for example, by using one or more computer codes and/or languages, alphanumeric character strings, data sets, figures, tables, charts, links, documents, and/or the like. Further, in some embodiments, the datastore 338 may include information associated with one or more applications, such as, for example, the system application 337. It will also be understood that, in some embodiments, the datastore 338 provides a substantially real-time representation of the information stored therein, so that, for example, when the processor 334 accesses the datastore 338, the information stored therein is current or substantially current.

It will be understood that the embodiment of the system environment illustrated in FIG. 3 is exemplary and that other embodiments may vary. As another example, in some embodiments, the system 330 includes more, less, or different components. As another example, in some embodiments, some or all of the portions of the system environment 300 may be combined into a single portion. Likewise, in some embodiments, some or all of the portions of the system 330 may be separated into two or more distinct portions.

In addition, the various portions of the system environment 300 may be maintained for and/or by the same or separate parties. For example, the system 330 and the external system 320 may be maintained by separate parties.

It will also be understood that the system 330 may include and/or implement any embodiment of the present invention described and/or contemplated herein. For example, in some embodiments, the system 330 is configured to implement any one or more of the embodiments of the process flow 100 and 200 described and/or contemplated herein in connection with FIGS. 1 and 2 or any other process flow described herein.

In some embodiments, one or more of the portions of the process flows represented by blocks 110-130 and 210-250 are triggered by one or more triggering events, which, in some embodiments, include the performance of one or more of the other portions of the process flow represented by blocks 110-130 and 210-250. Also, in some embodiments, the system executing process flows 100 and 200 are configured to perform one or more portions (or combinations of portions) of the process flows represented by blocks 110-130 and 210-250, from start to finish, within moments, seconds, and/or minutes.

As will be appreciated by one skilled in the art, aspects of the present embodiments of the invention may be embodied as a system, method, or computer program product. Accordingly, aspects of the present invention may take the form of an entirely hardware embodiment, an entirely software embodiment (including firmware, resident software, micro-code, and the like) or an embodiment combining software and hardware aspects that may all generally be referred to herein as a “circuit,” “module” or “system.” Furthermore, aspects of the present embodiments of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, and the like, or any suitable combination of the foregoing. Computer program code for carrying out operations for aspects of the present embodiments of the invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present embodiments of the invention are described below with reference to flowchart illustrations and/or block diagrams of methods, apparatus (systems) and computer program products according to embodiments of the embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for providing retroactive document retention of documents and/or data associated with a participant in a document retention service, the system comprising:
a computing platform including at least one processor and a storage device;
one or more databases comprising a plurality of electronic documents and data items;
a software module stored in the storage device, comprising executable instructions that when executed by the processor cause the processor to:
identify one or more data items in the one or more databases having a retention date prior to a date of enrollment into the document retention service;
retroactively apply the document retention service to the one or more data items by modifying a retention time for each of the one or more data items, wherein the retention time is extend for a predetermined time in accordance with one or more terms of the document retention service.

2. The system of claim 1, the software module further comprises executable instructions that when executed by the processor cause the processor to:
aggregate information associated with the identified one or more data items in the one or more databases.

3. The system of claim 2, the software module further comprises executable instructions that when executed by the processor cause the processor to:
generate a report based at least partially on the aggregated information associated with the identified one or more data items in the one or more databases.

4. The system of claim 3, the software module further comprises executable instructions that when executed by the processor cause the processor to:
determine one or more features of the data items, wherein the one or more features include a file size and a retention date; and
determine a price or cost for retroactively applying the document retention service to the one or more data items based at least partially on the report and/or the one or more features of each of the data items.

5. The system of claim 1, wherein the retention date is a date on which each of the one or more data items were stored within the one or more databases, and wherein the retention time is an amount of time each of the one or more data items will be stored beginning from the retention date for each of the one or more data items.

6. The system of claim 1, the software module further comprises executable instructions that when executed by the processor cause the processor to:
use a pricing model to determine a price for the retroactive application of the document retention service to the one or more data items, wherein the pricing model comprises a plurality of variables for determining a price, where each of the plurality of variables relates to one or more of a plurality of features of each of the one or more data items.

7. The system of claim 1, wherein the document retention service comprises one or more terms for extending retention times of data items stored on or beyond the date of enrollment by the participant, and wherein the document retention service further comprises a retroactive document retention feature for applying the one or more terms to documents associated with the participant having the retention date prior to the date of enrollment of the document retention service.

8. A computer program product for providing retroactive document retention of documents and/or data associated with a participant in a document retention service, the computer program product comprising a non-transitory computer-readable storage medium having computer-readable program code stored thereon, such that when the computer-readable code is executed by a computer processor it causes the computer to:
identify one or more data items in the one or more databases having a retention date prior to a date of enrollment into the document retention service;
retroactively apply the document retention service to the one or more data items by modifying a retention time for each of the one or more data items, wherein the retention time is extend for a predetermined time in accordance with one or more terms of the document retention service.

9. The computer program product of claim 8, further comprising computer-readable code that when executed by a computer processor causes the computer to:
aggregate information associated with the identified one or more data items in the one or more databases.

10. The computer program product of claim 9, further comprising computer-readable code that when executed by a computer processor causes the computer to:
generate a report based at least partially on the aggregated information associated with the identified one or more data items in the one or more databases.

11. The computer program product of claim 10, further comprising computer-readable code that when executed by a computer processor causes the computer to:
determine one or more features of the data items, wherein the one or more features include a file size and a retention date; and
determine a price or cost for retroactively applying the document retention service to the one or more data items based at least partially on the report and/or the one or more features of each of the data items

12. The computer program product of claim 8, wherein the retention date is a date on which each of the one or more data items were stored within the one or more databases, and wherein the retention time is an amount of time each of the one or more data items will be stored beginning from the retention date for each of the one or more data items.

13. The computer program product of claim 8, further comprising computer-readable code that when executed by a computer processor causes the computer to:
use a pricing model to determine a price for the retroactive application of the document retention service to the one or more data items, wherein the pricing model comprises a plurality of variables for determining a price, where each of the plurality of variables relates to one or more of a plurality of features of each of the one or more data items.

14. The computer program product of claim 8, wherein the document retention service comprises one or more terms for extending retention times of data items stored on or beyond the date of enrollment by the participant, and wherein the document retention service further comprises a retroactive document retention feature for applying the one or more terms to documents associated with the participant having the retention date prior to the date of enrollment of the document retention service.

15. A computer-implemented method for providing retroactive document retention of documents and/or data associated with a participant in a document retention service, the computer-implemented method comprising:
using a computer processor comprising computer program code instructions stored in a non-transitory computer readable medium, wherein said computer program code instructions are structured to cause said computer processor to:
identify one or more data items in the one or more databases having a retention date prior to a date of enrollment into the document retention service;
retroactively apply the document retention service to the one or more data items by modifying a retention time for each of the one or more data items, wherein the retention time is extend for a predetermined time in accordance with one or more terms of the document retention service.

16. The computer-implemented method of claim 15, further comprises computer program code instructions that are structured to cause said computer processor to:
aggregate information associated with the identified one or more data items in the one or more databases.

17. The computer-implemented method of claim 16, further comprises computer program code instructions that are structured to cause said computer processor to:
generate a report based at least partially on the aggregated information associated with the identified one or more data items in the one or more databases.

18. The computer-implemented method of claim 17 further comprises computer program code instructions that are structured to cause said computer processor to:
determine one or more features of the data items, wherein the one or more features include a file size and a retention date; and
determine a price or cost for retroactively applying the document retention service to the one or more data items based at least partially on the report and/or the one or more features of each of the data items

19. The computer-implemented method of claim 15, wherein the retention date is a date on which each of the one or more data items were stored within the one or more databases, and wherein the retention time is an amount of time each of the one or more data items will be stored beginning from the retention date for each of the one or more data items.

20. The computer-implemented method of claim 15 further comprises computer program code instructions are structured to cause said computer processor to:
use a pricing model to determine a price for the retroactive application of the document retention service to the one or more data items, wherein the pricing model comprises a plurality of variables for determining a price, where each of the plurality of variables relates to one or more of a plurality of features of each of the one or more data items.
